(19) United States
(12) Patent Application Publication
(10) Pub. No.: US 2013/0238394 A1
(43) Pub. Date: Sep. 12, 2013

(54) SALES PROJECTIONS BASED ON MENTAL STATES

(71) Applicant: AFFECTIVA, INC., Waltham, MA (US)

(72) Inventors: Rana el Kaliouby, Waltham, MA (US); Evan Kodra, Cambridge, MA (US); Rosalind Wright Picard, Newtonville, MA (US)

(73) Assignee: Affectiva, Inc., Waltham, MA (US)

(21) Appl. No.: 13/867,049

(22) Filed: Apr. 20, 2013

Related U.S. Application Data
(63) Continuation-in-part of application No. 13/153,745, filed on Jun. 6, 2011.
Application No. 13/153,745 is a continuation-in-part of application No. 13/708,214, filed on Dec. 7, 2012.
(60) Provisional application No. 61/636,634, filed on Apr. 21, 2012.
(60) Provisional application No. 61/747,651, filed on Dec. 31, 2012.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/568,130, filed on Dec. 7, 2011.
(60) Provisional application No. 61/581,913, filed on Dec. 30, 2011.

(51) Int. Cl. G06Q 30/02

(52) U.S. Cl. CPC G06Q 30/0202; G06Q 30/0242
USPC 705/7.31; 705/14.41; 705/14.45

(57) ABSTRACT

Analysis of mental states is performed in order to project sales. Projections may be based on effectiveness of an advertisement, a product, or a service. Effectiveness may be based on various objectives including entertainment, education, awareness, persuasion, startling, and drive to action. Data, including facial information and physiological information, is captured for an individual viewer or group of viewers. In some embodiments, demographics information is also collected and used as a criterion for rendering the mental states of the viewers in a graphical format. In some embodiments, data captured from an individual viewer or group of viewers is used to optimize sales projections.

### RELATED APPLICATIONS

This application claims the benefit of U.S. provisional patent applications “Sales Projections Based on Mental States” Ser. No. 61/636,634, filed Apr. 21, 2012 and “Optimizing Media Based on Mental State Analysis” Ser. No. 61/747,651, filed Dec. 31, 2012. This application is also a continuation-in-part of U.S. patent application “Mental State Analysis Using Web Services” Ser. No. 13/153,745, filed Jun. 6, 2011 which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Data Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. This application is also a continuation-in-part of U.S. patent application “Affect Based Evaluation of Advertisement Effectiveness” Ser. No. 13/708,214, filed Dec. 7, 2012 which claims the benefit of U.S. provisional patent applications “Mental State Evaluation Learning for Advertising” Ser. No. 61/568,130, filed Dec. 7, 2011 and “Affect Based Evaluation of Advertisement Effectiveness” Ser. No. 61/581,913, filed Dec. 30, 2011. The foregoing applications are hereby incorporated by reference in their entirety.

### FIELD OF ART

This application relates generally to analysis of mental states and more particularly to sales projections based on mental states.

### BACKGROUND

The evaluation of human mental states is key to understanding people and the ways in which they react to and interact with the world around them. Human mental states may range widely, from happiness to sadness, from contentedness to worry, from excitement to calm, as well as numerous others. These mental states may be experienced in response to everyday events such as frustration during a traffic jam, boredom while standing in line, and impatience while waiting for a cup of coffee. Individuals may perceive the mental states of those around them, and, based on this perception and understanding of mental states, empathize with other people. While an empathetic person may easily perceive another's anxiousness or joy and respond accordingly, automated evaluation of mental states is significantly more challenging. The ability and means by which one person perceives another's emotional state may be quite difficult to summarize, relate, or recreate; this ability to perceive another person's mental state often comes from a person's so-called “gut feel.”

The mental state experienced by a person can be tied to certain drives or behaviors. Emotional connections can be understood and the resulting behavior evaluated. Confusion, concentration, and worry may be identified by various means in order to aid in the understanding of the mental states and actions of an individual or group. People who witness a catastrophe may collectively respond with fear or anxiety. Similarly, people who witness their favorite sports team win a major victory may collectively respond with happy enthusiasm. Examining certain facial expressions and head gestures of an individual or group of people may facilitate mental state identification. Limited automation has been performed in the evaluation of mental states based on facial expressions. Certain physiological conditions may further provide telling indications of a person's state of mind. These physiological conditions have been used to date, but only in a crude fashion, for example, the apparatus used for polygraph tests.

### SUMMARY

Analysis of mental states may be performed while a viewer or viewers observe an advertisement or advertisements, or view and experience products or services. Analysis of the mental states of the viewers may indicate whether the viewers are, or will be, favorably disposed to an advertisement and the product or service described therein. A computer-implemented method for sales projection is described comprising: collecting mental state data from a plurality of people, analyzing the mental state data to produce mental state information, and projecting sales based on the mental state information.

A plurality of people may observe one of an advertisement, a product, and a service. The observing may be accomplished using a digital display. The plurality of people may experience one of a product and a service by, for example, through touch and smell. Actual sales to the plurality of people may be tracked. A sales score may be generated. The sales score may be posted to a social networking page such as FACEBOOK™, GOOGLE+™, YOUTUBE™, TUMBLR™, TWITTER™, DIGG™, or the like. The projecting of sales may further comprise projecting sales for demographics. The analyzing may include an evaluation of expressiveness. The projecting may be based on economic trends. The projecting may be based on market predictors. The market predictors may include information on target markets, promotion, and placement. The analyzing may include computing a likelihood to buy for an individual based on collected mental state data. The projecting of sales uses one or more effectiveness descriptors and an effectiveness classifier.

The projecting of effectiveness may use one or more effectiveness descriptors and an effectiveness classifier. The one of the one or more effectiveness descriptors may have a larger standard deviation and the larger standard deviation may correspond to higher advertisement effectiveness. The method may further comprise developing norms based on a plurality of advertisements and wherein the norms are used in the projecting. The method may further comprise combining a plurality of effectiveness descriptors to develop an expressiveness score wherein a higher expressiveness score corresponds to a higher advertisement effectiveness. The expressiveness score may be related to total movement for faces of the plurality of people. Probabilities for one of the one or more effectiveness descriptors may vary for portions of the advertisement. The probabilities may be identified at a segment in the advertisement when a brand is revealed. The method may further comprise generating a histogram of the probabilities. The portions may include quarters of the advertisement and the quarters may include at least a third quarter and a fourth quarter. A fourth-quarter probability for the advertisement may be higher than a third-quarter probability for the advertisement wherein the fourth quarter having a higher probability corresponds to higher advertisement effectiveness. The one of the one or more effectiveness descriptors may include one of AU12 and valence. The probabilities may increase with multiple views of the advertisement. The probabilities which increase may move to earlier points in time for the advertisement.

The method may further comprise establishing a baseline for the one or more effectiveness descriptors. The method may further comprise building an effectiveness probability wherein a higher effectiveness probability correlates to a higher likelihood that the advertisement is effective. The method may further comprise predicting an advertisement effectiveness where the advertisement effectiveness is based on an advertisement objective which includes one or more of a group comprising entertainment, education, awareness, persuasion, startling, and drive to action. The method may further comprise predicting virality for the advertisement. The method may further comprise aggregating the mental state information into an aggregated mental state analysis which is used in the projecting. The method may further comprise optimizing the advertisement based on the advertisement effectiveness which was projected. The mental state data also may include one of a group comprising physiological data and actigraphy data. A webcam may be used to capture one or more of the facial data and the physiological data. The method may further comprise comparing the advertisement effectiveness that was projected with actual sales. The method may further comprise inferring mental states about the advertisement based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity. Confusion may correspond to a lower level of advertisement effectiveness. The method may further comprise presenting a subset of the mental state information in a visualization. The visualization may be presented on an electronic display. The visualization may further comprise a rendering based on the advertisement.

In embodiments, a computer program product embodied in a non-transitory computer readable medium may comprise code for collecting mental state data from a plurality of people, code for analyzing the mental state data to produce mental state information, and code for projecting sales based on the mental state information. In some embodiments, a computer system for sales projections based on mental states may comprise a memory which stores instructions and one or more processors attached to the memory wherein the one or more processors, when executing the instructions which are stored, are configured to: collect mental state data from a plurality of people, analyze the mental state data to produce mental state information, and project sales based on the mental state information.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for sales projections based on mental states.

FIG. 2 is a system diagram for capturing mental state data.

FIG. 3 is a graphical representation of mental state analysis.

FIG. 4 is an example dashboard diagram for mental state analysis.

FIG. 5 is a diagram showing a graph and histogram for an advertisement.

FIG. 6 is a system diagram for evaluating mental states.

### DETAILED DESCRIPTION

The present disclosure provides a description of various methods and systems for sales projections based on analyzing people's mental states, particularly as people evaluate advertisements, products, and services. Viewers may observe advertisements, products, and services, while data is collected on their mental states. Mental state data from one viewer or a plurality of viewers may be processed to produce an aggregated mental state analysis which may be used to determine quantitative sales projections. Computer analysis may be performed on facial and/or physiological data to determine viewers' mental states as they observe various types of advertisements, products, and services. A mental state may be a cognitive state, an emotional state, or a combination thereof. Examples of emotional states include happiness or sadness, while examples of cognitive states include concentration or confusion. Observing, capturing, and analyzing these mental states can yield significant information about viewers' reactions to various stimuli.

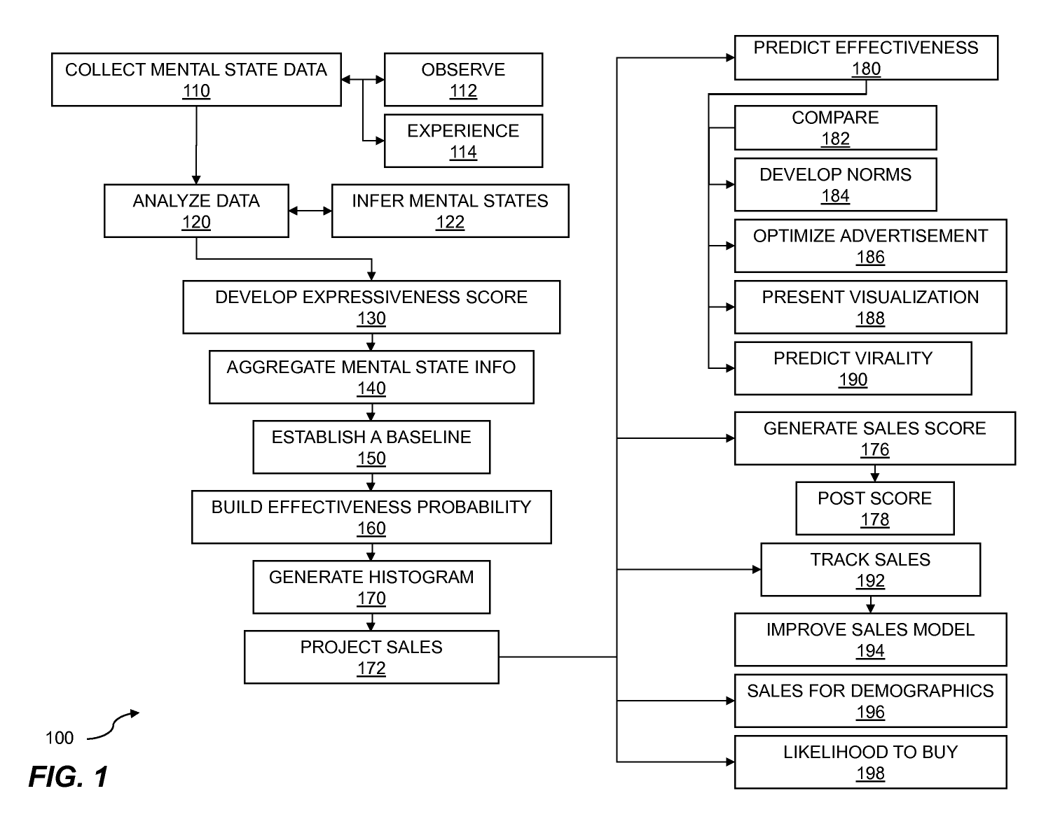

FIG. 1 is a flow diagram for sales projections based on mental states. The flow 100 describes a computer-implemented method for sales projection. The evaluation may be based on analysis of viewer mental state. The flow 100 may begin with collecting mental state data 110 from a plurality of people as they observe 112 an advertisement. Mental state data may also be collected from a plurality of people as they experience 114 a product or service. The mental state data may include facial data. An advertisement may be observed 112 on a digital display. The electronic display may be any electronic display, including but not limited to, a computer display, a laptop screen, a net-book screen, a tablet computer screen, a cell phone display, a mobile device display, a television, a projection apparatus, or the like. The advertisement may include a product advertisement, a service advertisement, an entertainment advertisement, an educational message, a social awareness advertisement, a drive-to-action advertisement, a political advertisement, and the like. In some embodiments, the advertisement is shown as part of a live event. The collecting of mental state data may be designed to assist in the evaluation of an advertisement. The mental state data 110 on the viewer may also include physiological data and actigraphy data. Physiological data may be obtained from video observations of a person. For example, heart rate, heart rate variability, autonomic activity, respiration, and perspiration may be observed via video capture. Alternatively, in some embodiments, a biosensor may be used to capture physiological information and accelerometer readings. Permission may be requested and obtained prior to the collection of mental state data. The mental state data may be collected by a client computer system. A viewer or plurality of viewers may observe an advertisement or advertisements synchronously or asynchronously. In some embodiments, a viewer may be asked a series of questions about advertisements, and mental state data may be collected as the viewer responds to the questions. The plurality of people may experience a product or service 114. The experiencing may include touch and smell.

The flow 100 may continue with analyzing the mental state data 120 to produce mental state information. While mental state data may be raw data such as heart rate, mental state information may include the raw data or information derived from the raw data. The mental state information may include the mental state data or a subset thereof. The mental state information may include valence and arousal. The mental state information may include information on the mental states experienced by the viewer. Eye tracking may be observed with a camera and may be used to identify portions of advertisements viewers may find amusing, annoying, entertaining, distracting, or the like. Such analysis may be based on the processing of mental state data from a plurality of people who observe the advertisement. Some analysis may be performed on a client computer before that data is uploaded. Analysis of the mental state data may take many forms, and may be based on one viewer or a plurality of viewers. The analysis may include information on attention. An attention score may be determined based on where a viewer's face is directed as well as, in some embodiments, where the viewer's eyes are focused. In such a system, for example, if a viewer turns away from the advertisement he or she is experiencing, his or her attention score would drop. In embodiments, a low attention score corresponds to a low effectiveness for the advertisement. Likewise, if a viewer becomes distracted, the effectiveness of the advertisement is similarly lowered. An awareness index may be developed to identify a viewer's awareness of the product or service that is being advertised.

The flow 100 may continue with inferring mental states 122 about the advertisement based on the mental state data which was collected from a single viewer or a plurality of viewers wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity. The mental states inferred may be used to determine advertisement effectiveness. For example, one inference might be that confusion corresponds to a lower level of advertisement effectiveness. These mental states may be detected in response to viewing an advertisement or a specific portion thereof.

The analyzing may include an evaluation of expressiveness. The flow 100 may include combining a plurality of effectiveness descriptors to develop an expressiveness score 130 wherein a higher expressiveness score corresponds to a higher advertisement effectiveness. In some embodiments, the expressiveness score is related to a measurement of total movement for the faces of the plurality of people. The total movement may be calculated based on identified facial action units (AU). Alternatively, total movement may be calculated based on machine recognition of facial changes, movement of facial landmarks, and the like.

The flow 100 may continue with aggregating the mental state information 140 into an aggregated mental state analysis which is used in the projecting. The aggregated information is based on the mental state information from a plurality of viewers who observe the advertisement. The aggregated mental state information may include a probability for one or more effectiveness descriptors. In some embodiments, the effectiveness descriptors may be selected based on an advertisement objective. The probabilities of an effectiveness descriptor or a plurality of effectiveness descriptors may vary over time during the viewing of an advertisement. Various effectiveness descriptors may be considered and may include one or more of valence, action unit 4 (AU4), action unit 12 (AU12), and the like. The aggregated mental state information may allow the evaluation of the collective mental state of a plurality of viewers. In one representation, there may be “n” viewers of an advertisement and an effectiveness descriptor x^{k} may be used. In this situation, an effectiveness descriptor may be aggregated over “n” viewers as follows.

$${X}^{k} = {\sum }_{i = 1}^{n} {x}_{i}^{k} ( t )$$

Mental state data may be aggregated from a plurality of people—i.e. viewers—who have observed a particular advertisement. The aggregated information may be used to infer mental states of the group of viewers. The group of viewers may correspond to a particular demographic, such as men, women, or people between the ages of 18 and 30, for example. The aggregation may be based on sections of the population, demographic groups, and the like. Demographics may be collected for viewers and the demographic information may be used as part of the advertisement analysis. Groups may be aggregated separately for analysis based on demographics.

The flow 100 may continue with establishing a baseline 150 for the one or more effectiveness descriptors. The baseline may be established for an individual or for a plurality of individuals. The baseline may be used in the aggregated mental state analysis and may include one of a minimum effectiveness descriptor value, a mean effectiveness value, an average effectiveness value, and the like. The baseline may be removed from an effectiveness descriptor as follows:

\tilde{X}=X(t)−baseline

The flow 100 may continue with building an effectiveness probability 160 wherein a higher effectiveness probability correlates to a higher likelihood that the advertisement is effective. The effectiveness probability may be computed using a combination of multiple effectiveness descriptors. The effectiveness probability may change with respect to one or more of the viewers for the advertisement, the section of the advertisement being viewed, and the like. The effectiveness probability may provide an intensity level based on a combination of effectiveness descriptors. The effectiveness probability numerically indicates an advertisement's probability score, which gives an indicator of the advertisement's effectiveness.

The flow 100 may continue with generating a histogram 170 of the probabilities. The probabilities may relate to an effectiveness descriptor, multiple effectiveness descriptors, an effectiveness probability, and the like. For example, the histogram may represent a probability-over-time for a group of effectiveness descriptors. The histogram may include a summary probability for portions of the advertisement. For example, the portions may include quarters of the advertisement, where the quarters include at least a third quarter and a fourth quarter. Further, in embodiments, the fourth-quarter probability for an advertisement will have a higher value than the same advertisement's third-quarter probability, suggesting that the advertisement effectiveness is higher. In an alternative embodiment, probabilities are identified at a segment in the advertisement when a brand is revealed. As the brand is revealed, viewers' attention should be high and valence should be positive with corresponding probabilities. In embodiments, the histogram shows a probability of an effectiveness descriptor or a plurality of effectiveness descriptors, changes in probabilities over time, and the like.

The flow 100 may continue with projecting sales based on the mental state information 172. The projecting may be based on economic trends. The projecting may be based on market predictors. The market predictors may include information on target markets, price, promotion, and placement. The projecting of sales may use one or more effectiveness descriptors and an effectiveness classifier. One or more of the effectiveness descriptors may have a larger standard deviation where the larger standard deviation may correspond to higher advertisement effectiveness.

The flow 100 may continue with generating a sales score 176. The sales score may rate the effectiveness of an advertisement, product, or service. The higher the sales score, the more favorably the advertisement, product or service was received, and the more likely it is that a viewer or plurality of viewers will purchase the product.

The flow 100 may continue with posting the sales score to a social network 178. A viewer or plurality of viewers may choose to share with their friends their experience of viewing an advertisement or viewing and experiencing a product or service. The sharing may involve an individual posting their sales score. The sales score may be posted to any of a number of social networks including but not limited to FACEBOOK™, GOOGLE+™, YOUTUBE™, TUMBLR™, TWITTER™, DIGG™, and the like.

The flow 100 may continue with predicting an advertisement effectiveness 180 based on the mental state information. The predicting of the advertisement effectiveness may use one or more effectiveness descriptors and an effectiveness classifier. One or more of the effectiveness descriptors may have a larger standard deviation where the larger standard deviation may correspond to higher advertisement effectiveness.

The flow 100 may continue with comparing the predicted advertisement effectiveness 182 with actual sales. Observed sales behavior may include, but not be limited to, which product a viewer purchased, if the viewer chose to purchase a product. If the viewer chose not to participate or purchase a product, that information may also be recorded as sales behavior. In some embodiments, correlations may be determined between mental state and sales behavior. An advertisement can be projected to be either effective or ineffective based on probabilities and other statistics that result from the collected mental state data from viewers of the advertisement. Further, the advertisement effectiveness may, at least in part, be based on an advertisement objective which includes one or more of a group comprising entertainment, education, persuasion, startling, and drive to action. If an analysis of the mental state information gathered from a user or a plurality of users indicates that one or more of the advertisement objectives has been met, then the advertisement may be considered more effective. In many cases, an advertisement which is correctly projected to be effective will result in greater product or service sales.

The flow 100 may continue with developing norms 184, based on a plurality of advertisements, where the norms are used in projecting. A norm may be an expected value for an advertisement or advertisements. For example, an entertaining advertisement could have an expected norm for a specific descriptor, such as AU12. Therefore if an advertisement is expected to be entertaining, but does not elicit an AU12 response, the advertisement may be considered ineffective. Likewise, an effective advertisement that is expected to be entertaining should provide a positive valence.

The flow 100 may continue with optimizing the advertisement 186 based on the advertisement effectiveness which was projected. Additional advertisements may be labeled as being effective or ineffective, based on human coders, actual sales data, or the like. As mental state data is collected against these additional advertisements, the mental state data can be analyzed as described above and tested against an effectiveness classifier. An advertisement then may be optimized to maximize sales, for example. The flow 100 may include presenting a subset of the mental state information in a visualization 188. The visualization may be presented on an electronic display where the electronic display. The visualization may further comprise a rendering based on the advertisement.

The flow 100 may continue with predicting virality 190 for the advertisement. Some advertisements may create an Internet sensation because they may be deemed by viewers to be particularly entertaining, humorous, educational, awareness-enhancing, thought-provoking, persuasive, startling, shocking, motivating, and the like. An Internet sensation based on an advertisement may be driven by viewers of an advertisement wanting to share their viewing experiences with their friends and followers on the Internet. Such sharing may take place via a range of social media such as TWITTER™, FACEBOOK™, GOOGLE+™, DIGG™, TUMBLR™, YOUTUBE™, and the like. Sharing by a viewer or viewers may take place via a wide range of popular social media platforms. Thus, a higher predicted virality value may indicate a higher likelihood that an advertisement would go viral and thus become an Internet sensation. Various steps in the flow 100 may be changed in order, repeated, omitted, or the like without departing from the disclosed inventive concepts.

The flow 100 may continue with tracking actual sales 192 to the plurality of people who viewed an advertisement, product, or service. The sales data may be correlated with projected sales values to determine whether the projected sales values accurately described sales trends. The flow 100 may continue with using the actual sales figures to improve the modeling of sales projections 194. Once the actual sales FIGS. 192 have been determined, the sales models may be adapted in order to more closely correlate with actual sales of products and services.

The flow 100 may continue with projecting sales for various demographic groups 196. The demographic groups may correspond to gender, age range, income range, race, and the like. Accurate determination of the mental states of various demographic groups to measure responses to advertisements, products, or services may be used to project sales for those demographic groups. Further, the mental states may be used to determine the demographic group with which an individual viewer most closely aligns. The flow 100 may continue with identifying similarities between the plurality of people who observe an advertisement, or observe and experience a product or service, and a second population of people. The similarities may be based on demographics, behaviors, purchasing history, click-stream history, and the like. The identifying of similarities may be for a subset of the plurality of people and the second population of people. The subset may be targeted for specific advertisements. The similarities may include at least one of online and offline behavior. Online behaviors could include browsing history, online purchase history, mobile device usage, and the like. Various sources of information may be aggregated, including blogs, tweets, social network postings, news articles, and the like. Offline behaviors could include geographic location, club memberships, volunteer activities, in-store purchases, and so on.

The flow 100 may continue with analyzing likelihood to buy 198 for an individual based on mental state data collected. The mental state or states of an individual viewing an advertisement, or viewing and experiencing a product and service, may be analyzed to determine the likelihood that the viewer will purchase a product or service. The mental states, derived from facial data, physiological data, actigraphy data, and the like may be used for this likelihood determination. Various steps in the flow 100 may be changed in order, repeated, omitted, or the like without departing from the disclosed concepts. Various embodiments of the flow 100 may be included in a computer program product embodied in a non-transitory computer readable medium that includes code executable by one or more processors.

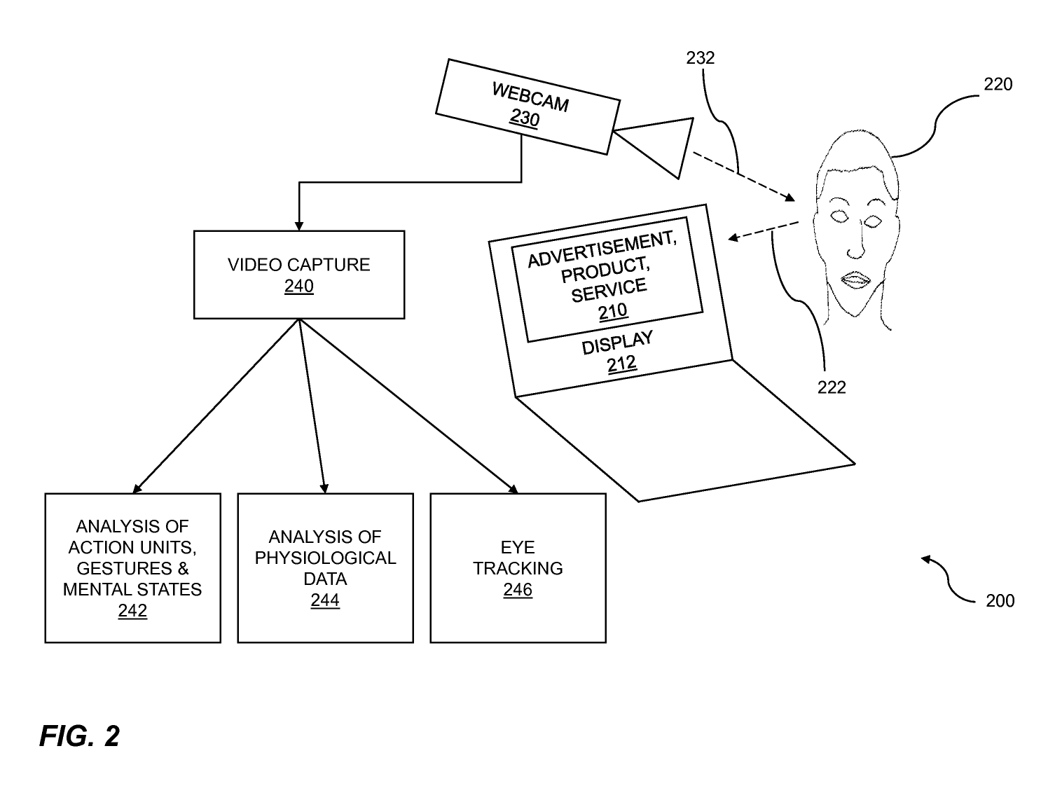

FIG. 2 is a system diagram for capturing mental state data in response to observing one of an advertisement, product, or service 210. A viewer 220 has a line-of-sight 222 to a display 212. The display 212 may be a television monitor, projector, computer monitor (including a laptop screen, a tablet screen, a net book screen, and the like), projection apparatus, a cell phone display, a mobile device, or other electronic display. While one viewer has been shown, in practical use, embodiments may analyze groups comprised of tens, hundreds, to thousands of people or more. Each viewer has a line of sight 222 to the advertisement, product, or service 210 rendered on the digital display 212. The advertisement 210 may be a political advertisement, an educational advertisement, a product advertisement, a service advertisement, and so on.

In embodiments, a webcam 230 is configured and disposed such that it has a line-of-sight 232 to the viewer 220. In one embodiment, the webcam 230 is a networked digital camera that may take still and/or moving images of the face and possibly the body of the viewer 220. The webcam 230 may be used to capture one or more of the facial data and the physiological data. The webcam 230 may refer to any camera including a webcam, a camera on a computer (such as a laptop, a net book, a tablet, or the like), a video camera, a still camera, a cell phone camera, a mobile device camera (including, but not limited to, a forward facing camera), a thermal imager, a CCD device, a three-dimensional camera, a depth camera, multiple webcams used to show different views of the viewers, or any other type of image capture apparatus that may allow captured image data to be used in an electronic system. In embodiments, the facial data from the webcam 230 is received by a video capture module 240 which may decompress the video into a raw format from a compressed format such as H.264, MPEG-2, or the like.

The raw video data may then be processed for analysis of facial data, action units, gestures, and mental states 242. Further, the facial data may include information on action units, head gestures, smiles, brow furrows, squints, lowered eyebrows, raised eyebrows, attention, and the like. The action units may be used to identify smiles, frowns, and other facial indicators of mental states. Gestures may include a head tilt to the side, a forward lean, a smile, a frown, as well as many other gestures. Physiological data may be analyzed 244 and eyes may be tracked 246. Physiological data may be obtained through the webcam 230 without contacting the individual. Respiration, heart rate, heart rate variability, perspiration, temperature, and other physiological indicators of mental state can be determined by analyzing the images. The physiological data may also be obtained by a variety of sensors, such as electrodermal sensors, temperature sensors, and heart rate sensors. The physiological data may include one of a group comprising electrodermal activity, heart rate, heart rate variability, respiration, and the like.

Eye tracking 246 of a viewer or plurality of viewers may be performed. The eye tracking may be used to identify a portion of the advertisement on which the viewer is focused. Further, the process may include recording of eye dwell time on the rendering and associating information on the eye dwell time to the rendering and to the mental states. The eye dwell time can be used to augment the mental state information to indicate the level of interest in certain renderings or portions of renderings. The webcam observations may include a blink rate for the eyes. For example, a reduced blink rate may indicate significant engagement in what is being observed.

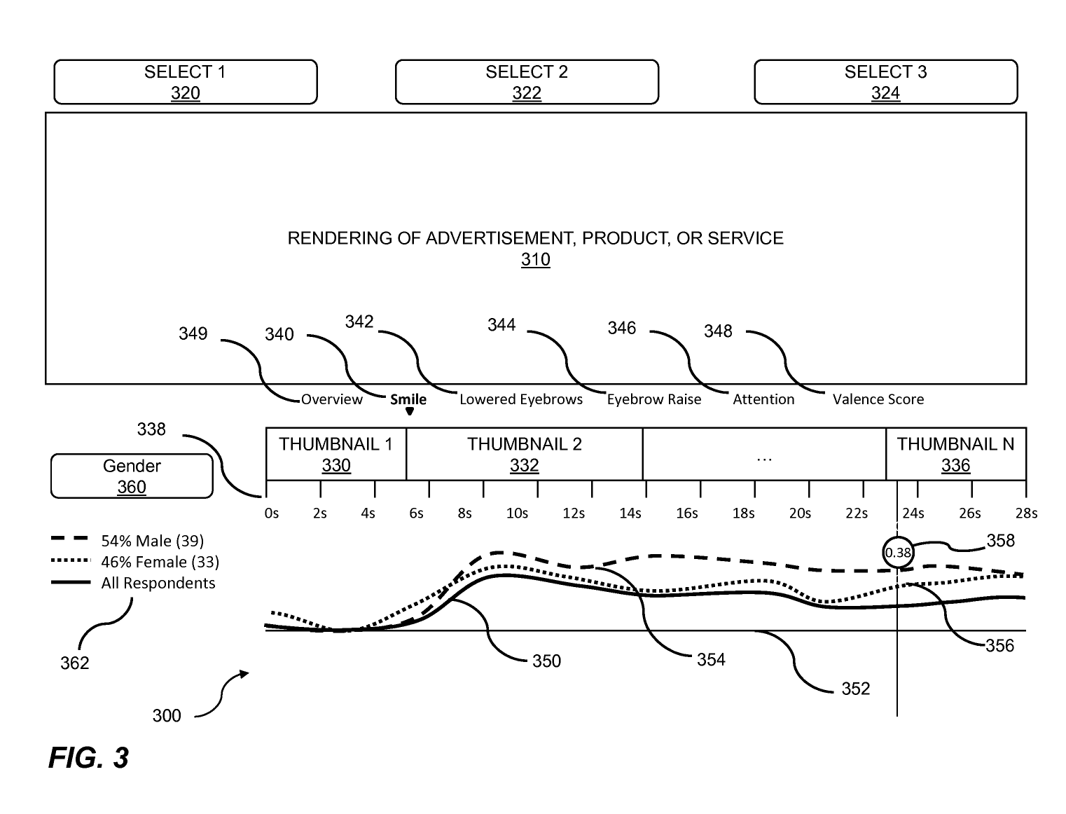

FIG. 3 is a graphical representation of mental state analysis that may be shown for sales projections and may be presented on an electronic display. The display may be a television monitor, projector, computer monitor (including a laptop screen, a tablet screen, a net book screen, and the like), a cell phone display, a mobile device, or another electronic display. A rendering of an advertisement, product, or service 310 may be presented in a window 300. An example window 300 is shown which includes the rendering 310 along with associated mental state information. A user may be able to select among a plurality of advertisements, products, or services using various buttons and/or tabs such as Select 1 button 320, Select 2 button 322, Select 3 button 324, and so on. Other numbers of selections are possible in various embodiments. In an alternative embodiment, a list box or drop-down menu is used to present a list of advertisements for display. The user interface allows a plurality of parameters to be displayed as a function of time, synchronized to the advertisement. Various embodiments may have any number of selections available for the user and some may be other types of renderings instead of video. A set of thumbnail images for the selected rendering, that in the example shown, include Thumbnail 1 330, Thumbnail 2 332, through Thumbnail N 336 may be shown below the rendering, along with a timeline 338. The thumbnails may show a graphic “storyboard” of the advertisement. This storyboard may assist a user in identifying a particular scene or location within the advertisement. Some embodiments may not include thumbnails, or may have a single thumbnail associated with the rendering, while various other embodiments may have thumbnails of equal length or differing lengths. In some embodiments, the start and/or end of the thumbnails may be determined based on changes in the captured viewer mental states as associated with the rendering, or may be based on particular points of interest in the advertisement. Thumbnails of one or more viewers may be shown along the timeline 338. The thumbnails of viewers may include peak expressions, expressions at key points in the advertisement, and the like.

Some embodiments may include the ability for a user to select a particular type of mental state information for display using various buttons or other selection methods. The mental state information may be based on one or more effectiveness descriptors. The one or more effectiveness descriptors may include one of AU12, AU4, and valence. For example, the smile mental state information is shown in the window 300, as the user may have previously selected the Smile button 340. Other types of mental state information that may be available for user selection in various embodiments may include the Lowered Eyebrows button 342, Eyebrow Raise button 344, Attention button 346, Valence Score button 348 or other types of mental state information, depending on the embodiment. An Overview button 349 may be available to allow a user to show graphs of the multiple types of mental state information simultaneously. The mental state information may include probability information for one or more effectiveness descriptors and the probabilities for the one of the one or more effectiveness descriptors may vary for portions of the advertisement.

Because the Smile option 340 has been selected in the example shown, a smile graph 350 may be shown against a baseline 352 showing the aggregated smile mental state information of the plurality of individuals from whom mental state data was collected as they viewed the advertisement 310. The male smile graph 354 and the female smile graph 356 may be shown so that the visual representation displays the aggregated mental state information. The mental state information may be based on various demographic groups as they react to the advertisement. The various demographic-based graphs may be indicated using various line types as shown or may be indicated using multiple colors or another method of differentiation. A slider 358 may allow a user to select a particular time of the timeline and show the value of the chosen mental state for that particular time. The mental states can be used to analyze the effectiveness of the advertisement. The slider 358 may show the same line type or color as the demographic group whose value is shown or another line type of color.

Various types of demographic-based mental state information can be selected using the demographic button 360, in some embodiments. Such demographics may include gender, age, race, income level, education, or any other type of demographic, including dividing the respondents into the respondents with higher reactions and the respondents with lower reactions. A graph legend 362 may be displayed indicating the various demographic groups, the line type or color for each group, the percentage of total respondents and/or absolute number of respondents for each group, and/or other information about the demographic groups. The mental state information may be aggregated according to the type of demographic information selected. Thus, for some embodiments, aggregation of the mental state information is performed on a demographic basis so that mental state information is grouped based on the demographic basis. An advertiser may be interested in evaluating the mental states of a particular demographic group.

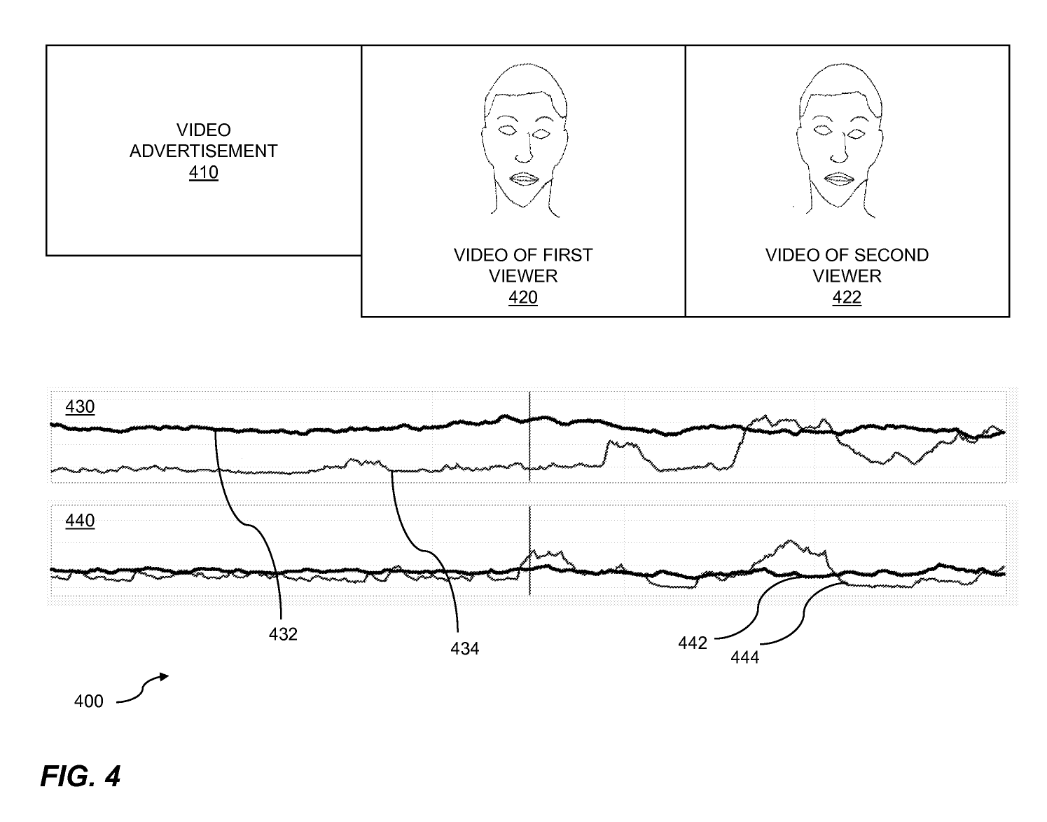

FIG. 4 is an example dashboard diagram for mental state analysis. The dashboard 400 may provide a visualization which is presented on an electronic display. The visualization may present all or a subset of the mental state information as well as the advertisement or a rendering based on the advertisement. The dashboard-type representation may be used to render a mental state analysis on a display. A display may be a television monitor, projector, computer monitor (including a laptop screen, a tablet screen, a net book screen, and the like), projection apparatus, a cell phone display, a mobile device, or another electronic display. A dashboard 400 may include a video advertisement 410, a product, or a service. The video advertisement 410 may be a video, a still image, a sequence of still images, a set of thumbnail images, and the like. The dashboard 400 may also include video of a viewer or a plurality of viewers. For example, the dashboard 400 may include video of a first viewer 420, video of a second viewer 422, and so on. The video for a viewer may be a video, a still image, a sequence of still images, a set of thumbnails, and so on.

The dashboard display 400 may allow for the comparison of graphs of various mental state parameters for a given user. The dashboard display 400 may allow for the comparison of graphs of various mental state parameters for a plurality of viewers. Various action unit graphs may be selected for display. For example, graph 430 may present two parameters AU4 432 and AU12 434 for the first viewer 420. Similarly, graph 440 may present two parameters AU4 442 and AU12 444 for a second viewer 422. The graphs 430 and 440 may relate to probabilities with the probabilities for one of the one or more effectiveness descriptors varying for portions of the advertisement, a product, or a service. Multiple other advertisement videos, video clips, stills, and the like may be shown.

As a practical example, an advertising team may wish to test the effectiveness of an advertisement. An advertisement may be shown to a plurality of viewers in a focus group setting. The advertising team may notice an inflection point in one or more of the curves, for example, a smile line. The advertising team can then identify which point in the advertisement, in this example a product advertisement, invoked smiles from the viewers. Thus, content can be identified by the advertising team as being effective or at least drawing a positive response. In this manner, viewer response can thus be obtained and analyzed.

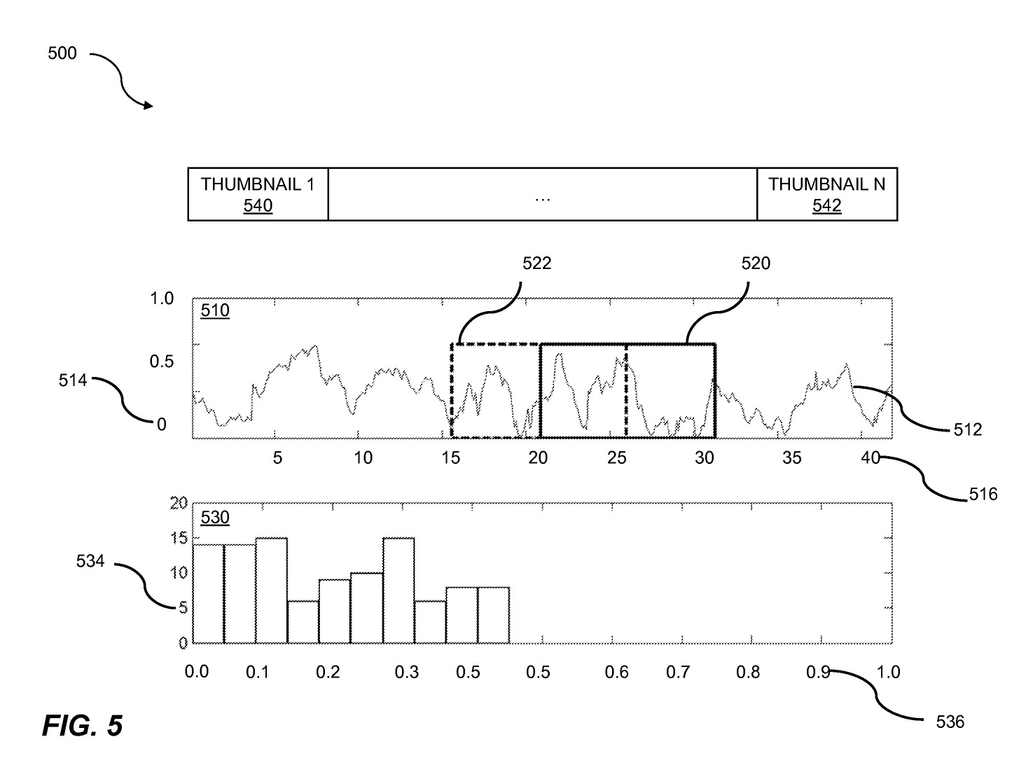

FIG. 5 is a diagram showing a graph and histogram for an advertisement. A window 500 may be shown which includes, for example, a series of thumbnails of an advertisement, product, or service including Thumbnail 1 540 through Thumbnail N 542. In an alternative embodiment, a list box or drop-down menu may be used to present a list of images. The associated mental state information 512 for an advertisement, product, or service may be displayed. Selections are possible in various embodiments including selecting the mental state data associated with temporal placement of certain thumbnails. In an alternative embodiment, a list box or drop-down menu may be used to present a list of times for display. The user interface allows a plurality of parameters to be displayed as a function of time, frame number, and the like, synchronized to the advertisement. A first window 510 is a display of affect showing an example display of probability for an effectiveness descriptor. The x-axis 516 may indicate relative time within an advertisement, a frame number, or the like. In this example, the x-axis 516 may be for a 45-second advertisement. The probability, intensity, or other parameter of an affect may be given along the y-axis 514. In some embodiments, a higher value or point on the mental state information graph 512 may indicate a stronger probability of a smile. A sliding window 520 may be used to highlight or examine a portion of the graph 510. For example, window 522 may be moved to the right to form window 520. These windows may be used to examine different times within the mental states collected for an advertisement, different periods within the advertisement, different quarters of the advertisement, and the like. In some embodiments, the window 520 can be expanded or shrunk as desired. Mental state information may be aggregated and presented as desired where the aggregated information includes the average, median, or other statistical or calculated value. The mental state information may be based on the information collected from an individual or a group of people. An advertisement effectiveness may be based on an advertisement objective which includes one or more of a group comprising entertainment, education, awareness, persuasion, startling, and drive to action. Other advertisement objectives are also possible.

An overall window 500 may include a histogram 530 of probabilities. The histogram may display the frequencies of probabilities from a previous window 510. The histogram 530 may be for an entire advertisement. Alternatively, the histogram 530 may be constructed based on the position of a timing window 520. In this case, the histogram 530 describes frequencies of the probabilities from the mental state information graph 512. The histogram 530 may be generated for portions of the mental state information for the advertisement. The portions may include quarters of the advertisement based on the advertisement being divided into four periods of time. The portions may include quarters of the advertisement and the quarters may include at least a third quarter and a fourth quarter being shown. In some embodiments, a fourth quarter probability for the advertisement may be higher than a third quarter probability for the advertisement. A fourth quarter with a higher probability may correspond to a higher advertisement effectiveness. In some embodiments, mental state information is gathered and used to compare and contrast a viewer's first, second, and subsequent exposures to an advertisement. The X-axis 536 for the histogram 530 may indicate probabilities. In this example, the Y-axis 534 may describe frequencies of those probabilities. In some embodiments, probabilities may increase with multiple views of the advertisement. When an advertisement is viewed repeatedly, certain probabilities, such as AU12 probabilities, may increase. Such an increase may indicate that an advertisement is effective. In embodiments, repeated viewings of an advertisement may lead to an earlier increase in probabilities within the advertisement. For example, an entertaining advertisement may elicit smiles, and, upon second and third viewings of the advertisement, the smiles may occur earlier as the viewer smiles in anticipation of previously enjoyed segments.

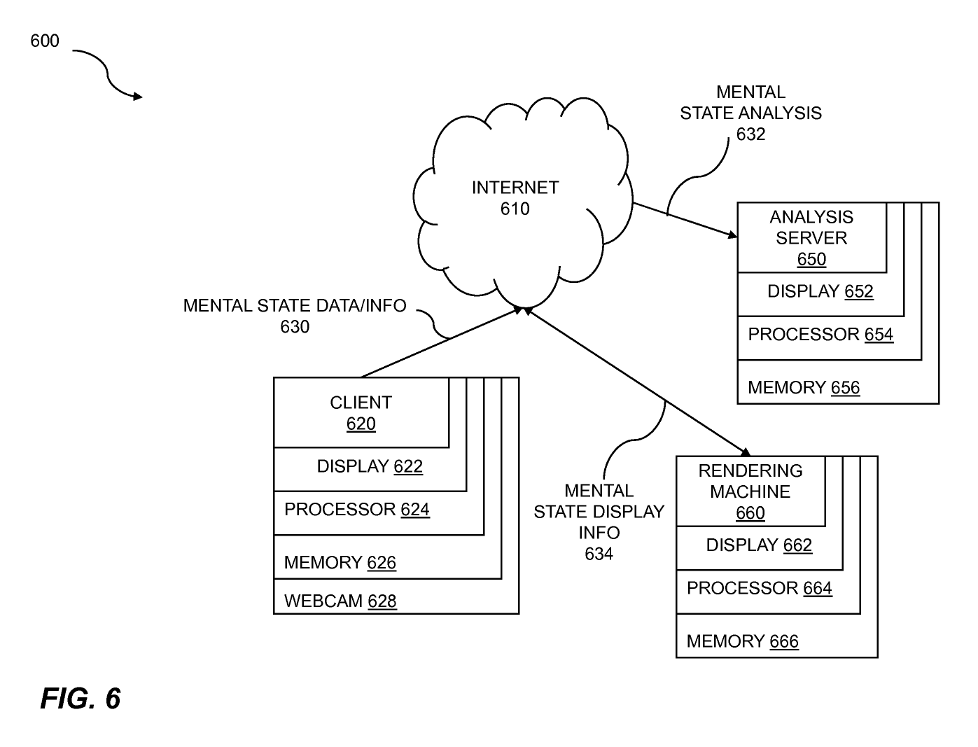

FIG. 6 is a system diagram for evaluating mental states used for sales projections. The diagram illustrates an example system 600 for mental state collection, analysis, and rendering. The system 600 may include one or more client machines 620 linked to an analysis server 650 via the Internet 610 or other computer network. The example client machine 620 comprises one or more processors 624 coupled to a memory 626 which can store and retrieve instructions, a display 622, and a webcam 628. The memory 626 may be used for storing instructions, mental state data, mental state information, mental state analysis, and sales information. The display 622 may be any electronic display, including but not limited to, a computer display, a laptop screen, a net-book screen, a tablet computer screen, a cell phone display, a mobile device display, a remote with a display, a television, a projector, or the like. The webcam 628 may comprise a video camera, still camera, thermal imager, CCD device, phone camera, three-dimensional camera, a depth camera, multiple webcams used to show different views of a person, or any other type of image capture apparatus that may allow captured data to be used in an electronic system. The processors 624 of the client machine 620 are, in some embodiments, configured to receive mental state data collected from a plurality of people to analyze the mental state data to produce mental state information. In some cases, mental state information may be output in real time (or near real time), based on mental state data captured using the webcam 628. In other embodiments, the processors 624 of the client machine 620 are configured to receive mental state data from one or more people, analyze the mental state data to produce mental state information and send the mental state information 630 to the analysis server 650.

The analysis server 650 may comprise one or more processors 654 coupled to a memory 656 which can store and retrieve instructions, and may include a display 652. The analysis server 650 may receive the mental state data and analyze the mental state data to produce mental state information so that the analyzing of the mental state data may be performed by a web service. The analysis server 650 may use mental state data or mental state information received from the client machine 620. This and other data and information related to mental states and analysis of the mental state data may be considered mental state analysis information 632. In some embodiments, the analysis server 650 receives mental state data and/or mental state information from a plurality of client machines and aggregates the mental state information.

In some embodiments, a rendering display of mental state analysis can occur on a different computer than the client machine 620 or the analysis server 650. This computer may be a rendering machine 660 which may receive mental state data 660, mental state analysis information, mental state information, and graphical display information collectively referred to as mental state display information 634. In embodiments, the rendering machine 660 comprises one or more processors 664 coupled to a memory 666 which can store and retrieve instructions, and a display 662. The rendering may be any visual, auditory, or other communication to one or more individuals. The rendering may include an email, a text message, a tone, an electrical pulse, or the like. The system 600 may include a computer program product embodied in a non-transitory computer readable medium for sales projection, the computer program product comprising: code for collecting mental state data from a plurality of people; code for analyzing the mental state data to produce mental state information; and code for projecting sales based on the mental state information.

Each of the above methods may be executed on one or more processors on one or more computer systems. Embodiments may include various forms of distributed computing, client/server computing, and cloud based computing. Further, it will be understood that for each flowchart in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. Each element of the block diagrams and flowchart illustrations, as well as each respective combination of elements in the block diagrams and flowchart illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, by a computer system, and so on. Any and all of which implementations may be generally referred to herein as a “circuit,” “module,” or “system.”

A programmable apparatus that executes any of the above mentioned computer program products or computer implemented methods may include one or more processors, microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are not limited to applications involving conventional computer programs or programmable apparatus that run them. It is contemplated, for example, that embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized. The computer readable medium may be a non-transitory computer readable medium for storage. A computer readable storage medium may be electronic, magnetic, optical, electromagnetic, infrared, semiconductor, or any suitable combination of the foregoing. Further computer readable storage medium examples may include an electrical connection having one or more wires, a portable computer diskette, a hard disk, a random access memory (RAM), a read-only memory (ROM), an erasable programmable read-only memory (EPROM), Flash, MRAM, FeRAM, phase change memory, an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the entity causing the step to be performed.

While the invention has been disclosed in connection with preferred embodiments shown and described in detail, various modifications and improvements thereon will become apparent to those skilled in the art. Accordingly, the spirit and scope of the present invention is not to be limited by the foregoing examples, but is to be understood in the broadest sense allowable by law.

What is claimed is:

1. A computer implemented method for mental state analysis comprising:
collecting mental state data from a plurality of people;
analyzing the mental state data to produce mental state information; and
projecting sales based on the mental state information.

2. The method of claim 1 a further comprising observing, by the plurality of people, one of an advertisement, a product, and a service.

3. The method of claim 2 wherein the projecting sales uses one or more effectiveness descriptors and an effectiveness classifier.

4. The method of claim 3 wherein one of the one or more effectiveness descriptors has a larger standard deviation and the larger standard deviation corresponds to higher advertisement effectiveness.

5. The method of claim 4 further comprising developing norms based on a plurality of advertisements where the norms are used in the projecting.

6. The method of claim 3 further comprising combining a plurality of effectiveness descriptors to develop an expressiveness score wherein a higher expressiveness score corresponds to a higher advertisement effectiveness.

7. The method of claim 6 wherein the expressiveness score is related to total movement for faces of the plurality of people.

8. The method of claim 3 wherein probabilities for one of the one or more effectiveness descriptors vary for portions of the advertisement.

9-13. (canceled)

14. The method of claim 8 wherein the probabilities increase with multiple views of the advertisement.

15. The method of claim 14 wherein the probabilities which increase move to earlier points in time for the advertisement.

16-17. (canceled)

18. The method of claim 2 further comprising predicting an advertisement effectiveness where the advertisement effectiveness is based on an advertisement objective which includes one or more of a group comprising entertainment, education, awareness, persuasion, startling, and drive to action.

19. (canceled)

20. The method of claim 18 further comprising comparing the advertisement effectiveness that was predicted with actual sales.

21-23. (canceled)

24. The method of claim 2 further comprising inferring mental states about the advertisement based on the mental state data which was collected wherein the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity.

25-27. (canceled)

28. The method of claim 1 further comprising experiencing, by the plurality of people, one of a product and a service.

29. The method of claim 1 further comprising tracking of actual sales to the plurality of people.

30. The method of claim 29 further comprising using the actual sales to improve modeling of sales projections.

31-32. (canceled)

33. The method of claim 1 wherein the projecting further comprises projecting sales for demographics.

34. The method of claim 1 wherein the analyzing includes evaluation of expressiveness.

35. (canceled)

36. The method of claim 1 wherein the projecting is based on market predictors.

37. The method of claim 36 wherein the market predictors include information on target market, price, promotion, and placement.

38. The method of claim 1 further comprising analyzing likelihood to buy for an individual based on mental state data collected.

39-43. (canceled)

44. A computer program product embodied in a non-transitory computer readable medium for sales projection, the computer program product comprising:
code for collecting mental state data from a plurality of people;
code for analyzing the mental state data to produce mental state information; and
code for projecting sales based on the mental state information.

45. A computer system for sales projection comprising:
a memory which stores instructions;
one or more processors attached to the memory wherein the one or more processors, when executing the instructions which are stored, are configured to:
collect mental state data from a plurality of people;
analyze the mental state data to produce mental state information; and
project sales based on the mental state information.
